(19) United States
(12) Patent Application Publication
(10) Pub. No.: US 2014/0300021 A1
(43) Pub. Date: Oct. 9, 2014

(54) Device for the manufacture of a bonded component from fibre-reinforced plastics and also a method

(71) Applicant: Airbus Operations GmbH, Hamburg (DE)

(72) Inventor: Heinz Bardenhagen, Stade (DE)

(21) Appl. No.: 14/234,711

(22) PCT Filed: Jul. 27, 2012
(86) PCT No.: PCT/EP2012/064828

§ 371 Date: May 12, 2014

Related U.S. Application Data
(60) Provisional application No. 61/512,007, filed on Jul. 27, 2011.

(30) Foreign Application Priority Data
Jul. 27, 2011 (DE) 102011079947.8

(51) Int. Cl. B29C 51/30; B29C 51/14

(52) U.S. Cl. CPC B29C 51/303; B29C 51/14; B29K 2063/00
USPC 264/101; 425/394

(57) ABSTRACT

A device and method for the manufacture of a bonded component from fiber-reinforced plastics, with a base molding tool and a molding tool. The bonded component is arranged between the base molding tool and the molding tool. The bonded component has at least one base laminate and at least one reinforcement laminate. The molding tool is covered with an aeration material and with a vacuum envelope. The vacuum envelope is sealed with respect to the base molding tool by means of a seal. At least one matrix material film is arranged underneath at least one molding tool overhang, in at least some regions. Undesirable cavities within the device are primarily filled with material from the matrix material film, so that leakage flows of matrix material from the bonded component reduce during the autoclave process. By this means complex and cost-intensive rework of the bonded component is avoided.

### CROSS-REFERENCES TO RELATED APPLICATIONS

This application claims the benefit of the U.S. Provisional Application No. 61/512,007, filed on Jul. 27, 2011, and of the German patent application No. 10 2011 079 947.8 filed on Jul. 27, 2011, the entire disclosures of which are incorporated herein by way of reference.

### BACKGROUND OF THE INVENTION

The invention concerns in the first instance a device for the manufacture of a bonded component with fiber-reinforced plastics, with at least one base molding tool and at least one molding tool, wherein the bonded component is arranged between the base molding tool and the molding tool and the bonded component has at least one base laminate and at least one reinforcement laminate, and the molding tool is covered with an aeration material and with a vacuum envelope, wherein the vacuum envelope is sealed with respect to the base molding tool by means of a seal.

For components in which high specific strengths and stiffnesses are required per unit weight, as, for example, in aerospace, fiber-reinforced plastics (FRPs) are often deployed. A fiber-reinforced plastic is a material that is formed from a multiplicity of reinforcing fibers that are embedded in a plastic matrix material. Carbon fibers, glass fibers, Kevlar®, aramide® fibers, natural fibers, or similar, are deployed, among others, as the reinforcing fibers. The plastic matrix often consists of a thermosetting plastic, such as, for example, an epoxy resin.

The manufacture of components from fiber-reinforced plastic can be undertaken using a multiplicity of methods, in which a curing process with the simultaneous application of pressure and temperature is generally a common component. If by virtue of the complexity of the components it is not possible to deploy heating presses, molding tools are used, into which the fiber-reinforced plastics are introduced. These molding tools can be closed, that is to say, surrounding the bonded component partly or fully, or can be embodied in an open manner. In the case of the open form of embodiment the pressure required is generally transferred directly onto the fiber-reinforced plastics, i.e., onto the bonded component, by means of a vacuum generation system. When additional molding tools are deployed a vacuum generation system is similarly used. Here the pressure is transferred via the molding tools onto the laminate layers of the fiber-reinforced plastics. Complex, integral fiber-reinforced plastic structures usually consist of a base laminate with reinforcing and connecting elements. These elements can be present as fiber-reinforced plastic components that have already been consolidated, as components of other materials, and also as fiber-reinforced plastic laminates.

Fiber-reinforced plastic laminates consist of two or a plurality of layers of fibers that have been pre-impregnated with a matrix material (so-called prepreg material), wherein the matrix material has not yet been cured. The reinforcing fibers can be present as a unidirectional layer, a woven fabric, a knitted fabric, or as a multi-layer mat.

To an increasing extent, large surface area, curved shells with longitudinal stiffeners, such as, for example, I-stringer profiles, are being manufactured from fiber-reinforced plastics in an integral form of construction. Such shells are constructed from at least one base laminate and a multiplicity of reinforcement laminates, such as, for example, stringer laminates, and other partial reinforcements (e.g., thickened sections) and other features as required. Such integrally reinforced shells, often curved in at least one dimension, are finding widespread application in aircraft construction, for example in the manufacture of lifting surfaces, ailerons, landing flaps, elevator units, vertical tail units, fuselage barrels, or similar items. Through the design of the base laminate, through reinforcements and insulation material and the deployment of further optional elements, complex components ensue with very diverse thicknesses and contours.

For the manufacture of such integrally reinforced shells in the first instance stringer laminates are positioned on molding tools provided with means of release, and the stringer laminates are then shaped. The molding tools are then brought together and at least one base laminate is laid down on the base molding tool, similarly provided with means of release. The molding tools are then brought into position on the at least one base laminate, are laid down, and a vacuum generation system is built on the arrangement to complete the device. The whole device is placed in an autoclave, in which curing of the bonded component takes place at high temperature and high pressure. In a final step of the method the finished bonded component is removed from the molding tool. As a general rule, curing in an autoclave is unavoidable if the pressure forces that can be achieved by means of a vacuum are insufficient. The molding tools of the devices of known art for the manufacture using moulds of integrally reinforced shells from fiber-reinforced plastics are often designed such that adjacent molding tools partially cover one another, or are covered by installed items of equipment. The aim here is to achieve laminate thickness levels that are as similar as possible. The same aim is sought if the release points on the upper faces of the cores are partially or completely covered with plates.

During the curing process the cavities formed by the molding tools and the overlaying vacuum generation system are filled with the fiber-reinforced plastic that has been introduced, in particular with its plastic matrix. However, in addition to the form-defining cavities that are required for the design of the bonded component, further undesirable voids are present. These undesirable voids essentially ensue as a result of gaps and/or capillaries between molding tools. Voids also ensue as a result of unfilled spaces underneath the molding tools, as caused by deviations of size and/or location of the laminate layers, and/or of the molding tools, and also as a result of differential thermal expansion of the molding tools. Furthermore cavities form, or already exist, within the vacuum generation system. As a rule these undesirable cavities fill up during the curing process at least partly with matrix material, since as a result of a pressure difference a transfer of material takes place from the laminates and into the voids. This pressure difference results from the difference between the pressure in the voids which corresponds approximately to the pressure in the aeration material of the vacuum generation system, i.e., to a partial vacuum or to normal atmospheric pressure—and the pressure in the matrix material, which in the ideal case is the same as the pressure in the autoclave. In particular, compensation flows of matrix material into cavities in the region of the overhang of the molding tools are caused as a result of this pressure difference.

As a rule the laminate thicknesses of bonded components from fiber-reinforced plastic are dimensioned in accordance with the lower nominal dimension anticipated. The lower tolerances that are important in this respect are often very tightly defined and only allow small deviations downwards. In particular in zones in which many parasitic cavities are located close to one another, such as, for example in the region of the end faces of a bonded component, there is often a failure to maintain the minimum permissible laminate thickness, which makes cost-intensive rework necessary.

### SUMMARY OF THE INVENTION

The object of the invention is therefore to specify a device for the manufacture using moulds of complex, integrally reinforced, bonded components from fiber-reinforced plastic, in which the parasitic cavities only occur to a reduced extent, so that even bonded components with minimum material thicknesses with tight tolerances can be produced without complex rework steps.

In that at least one matrix material film is arranged underneath at least one molding tool overhang, in at least some regions, it is primarily matrix material from the matrix material film that penetrates into the undesirable voids of the device, instead of matrix material from the bonded component. These parasitic voids are located to a greater extent in the region of the transverse faces (end faces) of the base laminate of the bonded component, which, as a rule have a significantly shorter length in relation to the longitudinal faces of the base laminate. As a result of the predominant filling of these voids with matrix material from the matrix material film, compensation flows of matrix material from the bonded component into the parasitic cavities are reduced, particularly during the curing process in the autoclave. This enables bonded components, in particular with minimum material thicknesses with tight tolerances, to be manufactured by means of the device in a reliable process without the requirement for complex rework. The at least one matrix material film is preferably formed from a thermosetting plastic material, such as, for example, an epoxy resin, a polyester resin, a phenol resin, or a BMI resin. The matrix material film preferably has an approximately rectangular cross-sectional geometry.

In accordance with an advantageous further development of the device provision is made that the fiber-reinforced plastic and the matrix material film are formed from the same matrix material.

By this means mixing processes occurring under some circumstances between the resin of the matrix material film and the resin of the bonded component do not lead to any kind of impairment of the mechanical strength of the bonded component.

In accordance with an advantageous further development of the device provision is made that the matrix material film is free of reinforcing fibers.

By virtue of this embodiment the resin can penetrate easily into the undesirable cavities of the device at the high temperatures that are usual in the autoclave.

In accordance with a further development of the device the matrix material film has a highly viscous consistency at room temperature.

By this means the matrix material film only becomes able to flow at a temperature in the autoclave that is higher in comparison to room temperature, such that it can infiltrate into gaps, capillaries and void of the device as a substitute for the matrix material from the bonded component.

In a further advantageous configuration of the device at least one sealing element is fitted to at least one end face of the bonded component, in at least some sections.

By virtue of the sealing element any compensation flow of resin material between the bonded component and the parasitic cavities is made more difficult. The at least one sealing element is preferably manufactured from a sufficiently elastic rubber-cork mixture. Alternatively the sealing element can also be formed from another plastic material that is sufficiently resistant to pressure and temperature.

In accordance with a further development of the device at least one filler element adjoins the at least one sealing element, in at least some sections.

The filler element is positioned in the overhang region of the at least one molding tool and forms an optional slump limiter for the molding tools located above the base molding tool. The use of a filler element allows the adaptation of the separation distance between the molding tool and the base molding tool. The at least one sealing element and the at least one filler element preferably have in each case an approximately rectangular cross-sectional geometry.

In accordance with an advantageous further development provision is made that the at least one filler element is formed from an elastomer.

The deformability of an elastomer ensures that the filler element adapts to a curved surface.

In a further configuration of the device provision is made that the at least one matrix material film is supported, in at least some regions.

As a consequence of this configuration a surface area of the matrix material film does not need to correspond exactly to the surface extent of the region between the molding tool overhang and the base molding tool, i.e., the filler element.

In addition it is an object of the invention to specify a method for the manufacture of bonded components from fiber-reinforced plastics, in which the number of undesirable parasitic voids is significantly reduced.

In the course of the inventive method at least one base laminate is laid down on the base molding tool in the first instance. At least one sealing element is fitted in each case in the region of at least one end face of the base laminate, i.e., of one transverse face of the bonded component. Optional filler elements are then fitted onto the sealing elements. In each overhang region at least one matrix material film is applied in each case. The matrix material film is preferably formed from the same resin system that is used for the fiber-reinforced plastic. Preformed reinforcement laminates with the associated molding tools are then laid down on the base laminate. The molding tools are overlaid with a release layer and with an aeration material. The whole system is then covered with a vacuum envelope to complete the device. The curing of the bonded component then takes place in an autoclave with the application of pressure and temperature.

### BRIEF DESCRIPTION OF THE DRAWINGS

In the figure:

FIG. 1 shows a schematic cross-sectional representation of part of an arrangement of prior known art for the manufacture of a bonded component of a fiber-reinforced plastic.

FIG. 2 shows a simplified longitudinal section through the arrangement of FIG. 1,

FIG. 3 shows a longitudinal section through an inventive arrangement, and

FIG. 4 shows a magnified representation of region IV in FIG. 3.

### DETAILED DESCRIPTION OF THE PREFERRED EMBODIMENTS

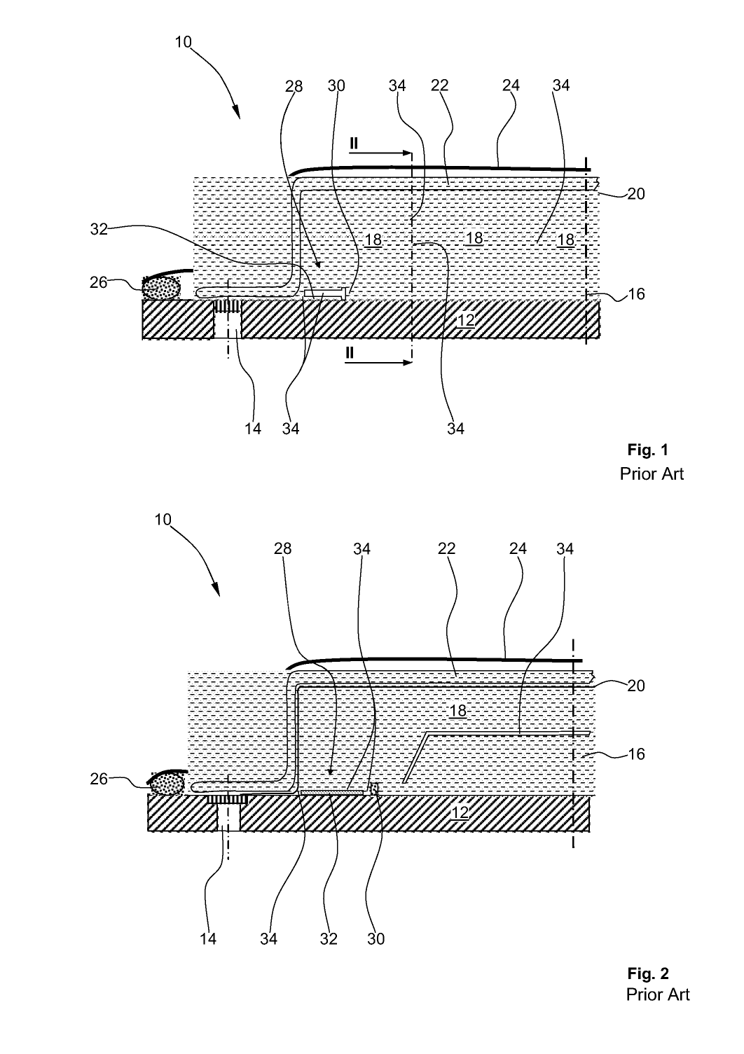

FIGS. 1 and 2, to which reference is made at the same time in the following description, show a schematic cross-sectional and longitudinal sectional representation of part of an arrangement of prior known art for the manufacture of a bonded component from a fiber-reinforced plastic. FIGS. 1, 2 show only the left-hand part of the symmetrical arrangement in each case.

An arrangement 10 comprises, among other items, a base molding tool 12 with at least one vacuum channel 14 arranged therein. On the base molding tool 12 is laid down a bonded component 16 of a fiber-reinforced plastic, which is built up from a base laminate, not designated, and a multiplicity of reinforcement laminates to provide integral reinforcement. On the bonded component 16 are furthermore located a multiplicity of form-defining molding tools 18. The molding tools 18 are provided with a release layer 20, i.e., a release film, which in turn is overlaid with an aeration material 22, which is usually formed from a polyester fleece or a polyester weave. Above the aeration material runs a vacuum envelope 24, which can be subjected to a reduced pressure, i.e., a partial vacuum, via the vacuum channel 14. The sealing of the vacuum envelope 24 with respect to the base molding tool 12 is undertaken with the aid of a seal 26. In the region of a molding tool overhang 28 a sealing element 30 adjoins the bonded component 16. By means of the sealing element 30, among other features, any flow of matrix material out of the bonded component 16 during the curing process in the autoclave at high temperature and pressure is designed to become more difficult. In addition the sealing element 30 prevents the reinforcing fibers from being washed out during the curing process and during the cooling-down phase it serves as an elastic buffer between the bonded component 16 and the molding tools 18 that on occasion shrink against the latter.

In addition to the sealing element 30 a filler element 32 is optionally arranged underneath the molding tool overhang 28 on the base molding tool 12; this primarily serves as a slump limiter for the molding tool 18 located above. Notwithstanding the presence of the sealing element 30 and the filler element 32 it has been demonstrated in practice that there is a flow of matrix material out of the bonded component 16 into a multiplicity of parasitic voids 34, in particular during the curing process for the bonded component 16. This flow of matrix material has its causes in the pressure difference between the high pressure (autoclave pressure) of the matrix material in the bonded component 16 and the significantly lower pressure (partial vacuum or ambient air pressure) in the region of the undesirable voids 34. The outflow of matrix material leads to a failure to maintain prescribed minimum material thicknesses, in particular in the region of the transverse, i.e., end, faces of the bonded component 16, which are shorter in relation to the longitudinal faces of the same; as a rule this failure makes complex rework of the bonded component 16 necessary. The undesirable parasitic voids 34 exist, for example, between the molding tools 18, above the molding tools 18, between the molding tool overhang 28 and the filler element 32, and within the vacuum generation system, not designated, in the form of a small void 34, i.e., a gusset, underneath the release layer 20 and the aeration material 22.

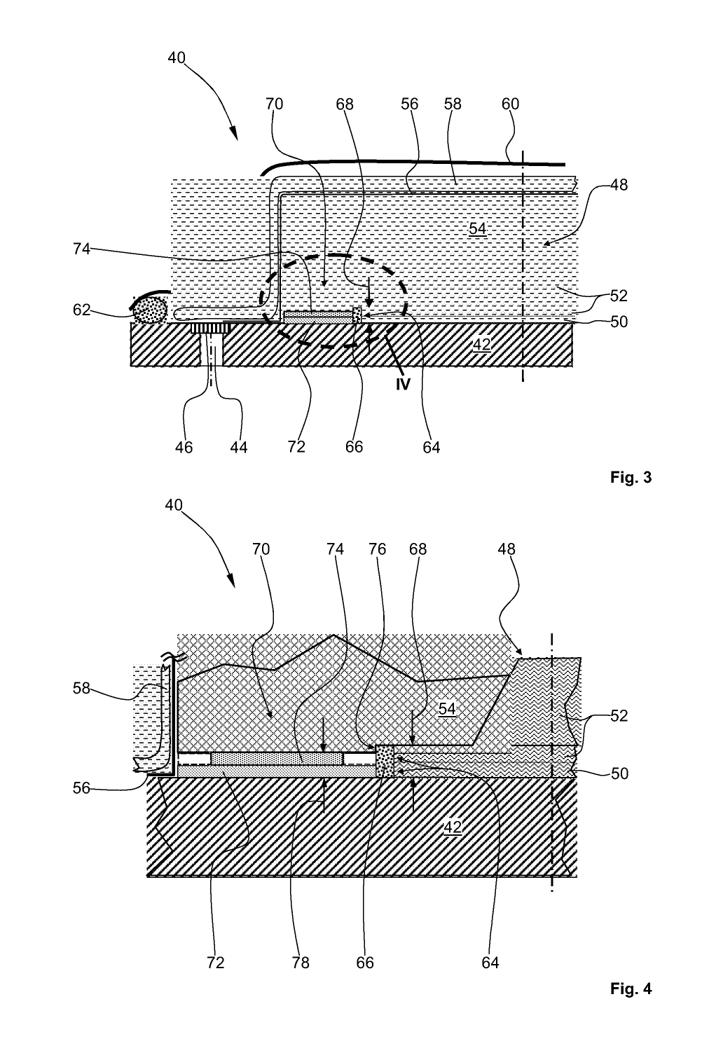

FIG. 3 shows a simplified representation of a longitudinal section through an inventive device, in which the resin losses explained above and the associated problems of reduced material thickness of the bonded component are to a large extent avoided. FIG. 3 shows only a left-hand section of the symmetrically built device.

The inventive device 40 comprises, among other items, a base molding tool 42 with a vacuum channel 44, and a perforated covering 46 located within the latter. On the base molding tool 42 lies a bonded component 48, which is built up from a base laminate 50 and at least one reinforcement laminate 52. The bonded component 48 takes the form, for example, of an integrally reinforced, essentially rectangular shell of a fiber-reinforced plastic, such as, for example, a carbon fiber-reinforced epoxy resin (CRP) or similar. The shell, i.e., the bonded component 48, has two end faces, i.e., transverse faces, which are significantly shorter in relation to the two longitudinal faces. Above the bonded component 50 are located a multiplicity of molding tools, of which only one molding tool 54 is visible in the representation of FIG. 3. The molding tool 54 is overlaid with a release layer 56 and an aeration material 58, which for its part is overlaid with a vacuum envelope 60. The aeration material 58 is usually formed with a polyester fleece or a polyester weave that has good gas permeability. In addition to the release layer 56 and the aeration material 58 the device 40 can have further functional layers, such as, for example, a tear-off layer or a resin removal layer. Hermetic sealing of the vacuum envelope 60 with respect to the base molding tool 42 is ensured by means of a peripheral seal 62, The seal 62 surrounds the whole periphery of what is here an essentially rectangular base molding tool 42 with the bonded component 48 that is lying on the latter. A partial vacuum can be produced and maintained underneath the vacuum envelope 60 with the aid of the vacuum channel 44 and a vacuum pump.

A sealing element 66 is fitted on an end face 64 of the bonded component 48. This is preferably produced with a sufficiently elastic mixture of rubber and cork and has an approximately rectangular cross-sectional geometry, the height of which, not designated, approximately corresponds with a material thickness 68 of the base laminate 50 and the reinforcement laminate 52. By means of the sealing element 66 the undesirable flow of matrix material out of the bonded component 48, in particular during the autoclave process, is reduced. Underneath a molding tool overhang 70 an optional filler element 70 directly adjoins the sealing element 66. The filler element 72 has an approximately rectangular cross-sectional geometry, and serves primarily to implement a vertical slump limiter for the molding tool 54 with respect to the base molding tool 42, while the device 40 is located in the autoclave for purposes of curing the bonded component 48. In order to implement an effective slump limiter, the filler element 72 is formed from a material with a sufficient mechanical and thermal load capacity. Underneath the (molding tool) overhang 70 of the molding tool 54 is positioned the inventive matrix material film 74. At room temperature the matrix material film 74 has a viscosity that is sufficiently high to prevent it from flowing in the state shown. Only when the device 40 is placed in the autoclave does the matrix material in the matrix material film 74 assume an increasingly low viscous state so as to ensure a penetrative capability of the resin that is as high as possible for the filling of the cavities.

By virtue of the matrix material film 74 it is inventively achieved that any undesirable voids within the device 40 are primarily filled with matrix material from the matrix material film 74, and only in a subsidiary manner with matrix material from the bonded component 48. By this means leakage flows of the matrix material out of the bonded component 48—in particular while it is being cured at high temperature and pressure in the autoclave—and into the parasitic cavities are reduced. By this effect the material thickness 68 of the two laminate layers 50, 52 of the bonded component 48 in the region of the end face 64 is reliably prevented from falling below a prescribed minimum thickness during the curing process in the autoclave. By virtue of this mechanism of the matrix material film 74 complex rework steps on the bonded component 48 become generally unnecessary, as a result of which a high cost saving potential ensues.

As a rule the matrix material film 74 is formed from the same material as that from which the bonded component 48 is also produced. If the laminates 50, 52 of the bonded component 48, for example, are formed from a carbon fiber-reinforced epoxy resin (CRP), then the matrix material film 74 is formed from the same epoxy resin, free of reinforcing fibers, and not yet cured ahead of the autoclave process. In a deviation from the arrangement of the matrix material film in accordance with FIG. 3, which is represented in a purely exemplary manner, the film can also be arranged in only some regions or sections on the filler element 72, and/or also directly on an upper face, not designated here, of the base molding tool 42, in each case underneath the peripheral molding tool overhang 70.

FIG. 4 shows a magnified representation of region IV from FIG. 3, wherein in contrast to the form of embodiment illustrated in FIG. 3 the matrix material film here only covers some regions of the filler element.

The device 40 comprises, among other items, the base molding tool 42 and the molding tool 54 with the bonded component 48 accommodated in between; the latter is built up from the base laminate 50 and the reinforcement laminate 52. Only the release layer 56 and the aeration material 58 of the vacuum generation system are partially represented in the interests of a better overview of the drawing. Depending on the particular conditions of a concrete application, in particular on the quantity of matrix material required as a substitute, the matrix material film 74 can, for example, be arranged along the sealing element 66 and the other—here not represented—edge face sealing element of the bonded component 48—either in some regions or over the full surface of the filler elements. Moreover the thickness of the matrix material film 74 can be adapted. It can correspondingly be arranged along the longitudinal faces of the bonded component 48. In this example of embodiment the molding tool 54 has on its lower face a peripheral recess 76, i.e., a small change in level of its lower face.

Depending on the particular concrete form of embodiment of the device 40, the material thicknesses 68 and 78 differ ahead of the curing process. As a result of the filler element 72 with the matrix material film 74 placed thereon, the molding tool 54 for practical purposes is “jacked up” on the base molding tool 42, that is to say, the autoclave pressure acts on the matrix material film 74. This in turn has the consequence that the material of the matrix material film 74, which is rapidly liquefying in the autoclave, is pressed at high pressure into any voids existing within the device 40. Matrix material from the bonded component 48 can no longer penetrate Into the cavities that are being filled in such a manner, with the result that the undesirable outflow of matrix material, in particular from the region of the two transverse faces, i.e., end faces, which in comparison to the longitudinal faces of the bonded component 48 are usually shorter, is to a large extent prevented. In the ideal case after completion of the autoclave process a direct contact exists, at least partially, between the molding tool overhang and the filler element.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### REFERENCE SYMBOL LIST

10. Arrangement
12. Base molding tool
14. Vacuum channel
16. Bonded component
18. Molding tool
20. Release layer (release film)
22. Aeration material
24. Vacuum envelope
26. Seal (vacuum envelope)
28. Molding tool overhang
30. Sealing element
32. Filler element
34. Void
40. Device
42. Base molding tool
44. Vacuum channel
46. Perforated covering (vacuum channel)
48. Bonded component (FRP)
50. Base laminate
52. Reinforcement laminate
54. Molding tool
56. Release layer
58. Aeration material
60. Vacuum envelope
62. Seal
64. End face (bonded component)
66. Sealing element
68. Material thickness
70. Molding tool overhang
72. Filler element
74. Matrix material film
76. Recess (molding tool)
78. Material thickness

1-9. (canceled)

10. A device for the manufacture of a bonded component with fiber-reinforced plastics, comprising:
at least one base molding tool and at least one molding tool,
the bonded component being arranged between the base molding tool and the molding tool,
the bonded component having at least one base laminate and at least one reinforcement laminate,
the molding tool being covered with an aeration material and with a vacuum envelope,
the vacuum envelope being sealed with respect to the base molding tool by means of a seal, and
at least one matrix material film being arranged underneath at least one molding tool overhang, in at least some regions.

11. The device in accordance with claim 10, wherein the fiber-reinforced plastic and the matrix material film are formed from the same matrix material.

12. The device in accordance with claim 10, wherein the matrix material film is free of reinforcing fibers.

13. The device in accordance with claim 10, wherein the matrix material film has a highly viscous consistency at room temperature.

14. The device in accordance with claim 10, wherein at least one sealing element is fitted on at least one end face of the bonded component, in at least some sections.

15. The device in accordance with claim 10, wherein at least one filler element adjoins the at least one sealing element, in at least some sections.

16. The device in accordance with claim 10, wherein the at least one filler element is formed from an elastomer.

17. The device in accordance with claim 10, wherein the at least one matrix material film is supported, in at least some regions.

18. A method for the manufacture of a bonded component with fiber-reinforced plastics using a device in accordance with claim 10.
